(19) United States
(12) Patent Application Publication
(10) Pub. No.: US 2014/0141838 A1
(43) Pub. Date: May 22, 2014

(54) MOBILE DEVICE CASE WITH INTERCHANGEABLE DISPLAY

(71) Applicant: UNU Electronics Inc., Union City, CA (US)

(72) Inventors: Sen Cai, Union City, CA (US); Weiguang Huang, Union City, CA (US)

(73) Assignee: UNU Electronics Inc., Union City, CA (US)

(21) Appl. No.: 14/083,177

(22) Filed: Nov. 18, 2013

Related U.S. Application Data
(60) Provisional application No. 61/727,562, filed on Nov. 16, 2012.

(51) Int. Cl. H04M 1/02; H04B 1/38

(52) U.S. Cl. CPC H04M 1/0254; H04B 1/3888; H04M 1/0266
USPC 455/557; 455/566; 455/573; 455/575.1; 455/575.8

(57) ABSTRACT

A mobile device case system includes a first case system component usable to at least partially enclose a mobile device. A second case system component is attachable to the first case component (e.g., mechanically and/or electronically) to provide additional features and functionality such as, for example, an expansion battery and/or an external display. The second case system component can be replaced with other system components to, for example, change the display, replace the battery, or provide a decorative cover for the external surface of the case system.

### CROSS-REFERENCE TO RELATED APPLICATIONS

This application claims the benefit of U.S. Patent Application Ser. No. 61/727,562 filed on Nov. 16, 2012, the disclosure of which is hereby incorporated by reference in its entirety.

### BACKGROUND OF THE INVENTION

1. Field of the Invention

This invention is related to a system, method, and apparatus usable for providing protection and increased battery life to mobile electronic devices. More particularly, this invention is related to a system of interchangeable mobile electronic device case components that are usable in a system to provide increased protection and/or increased battery life to the mobile electronic device. The present invention also relates to a system of interchangeable mobile electronic device case components that includes an integrated display.

2. Summary of the Invention

With the increased functionality of mobile phones and other portable electronic devices, and particularly smart phones, users have become adept at using their mobile electronic devices as a single informational portal. That is, users use their mobile electronic devices, such as smart phones, as communication devices (e.g., to make/receive phone calls, send/receive emails, or send/receive text, photo, video and other messages); as a data connection (e.g., to browse the interne, to access specialized information, or as a wi-fi “hot spot”); and even as general input devices (e.g., as a credit card reader, barcode scanner, QR code reader, or point of sale terminal).

However, these users have been limited in the way in which they interact with their mobile phones. Additionally, there are limited venues to display or generate information for the user. That is, the user is confined to operating within the existing framework of the mobile device when accessing information.

It would be very valuable to provide an additional method for interacting with a mobile electronic device. It would also be valuable to provide a different avenue for displaying information to users in a way that allows them to quickly and accurately make determinations based on that information.

Further, many phones have a breakable glass or plastic display, as well as other fragile parts. A thriving phone case industry has been built based on the fragile-nature of these phones. Protecting the phone, while still providing access to buttons, switches, lens, mikes and jacks is an essential element of a phone case.

Furthermore, with the increased functionality of mobile electronic devices and the increased manner of use, the battery life of such devices has become increasingly more important. That is, with the increased functionality has come an increased demand on power consumption. Likewise, the additional features mean that users spend more time using their devices and thus further increase the need for longer battery life. As such, there is an increasing need for external battery devices that increase the functional battery life of mobile electronic devices.

Traditionally, external battery devices have been large and cumbersome, often integrated into a case for the mobile electronic device that, when empty, takes up as much, if not more, cargo space as the mobile electronic device itself. Accordingly, users often leave such external battery devices detached from their mobile electronic devices until needed to extend the battery life of the device. In such situations, the user is required to carry both devices, effectively doubling the cargo size of the portable electronic device. It would be beneficial to provide a system that reduces the size of the detached external battery device when not connected to the mobile electronic device.

### BRIEF DESCRIPTION OF DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a perspective view of a mobile phone and a case system according to this invention;

FIG. 2 is a another perspective view of the mobile phone and case system shown in FIG. 1;

FIG. 3 is a perspective view of the mobile phone and case system of FIG. 1 and a stand, wherein the case system is displaying a digital clock feature;

FIG. 4 is a perspective view of a portion of the case system and the stand of FIG. 3 separated from the mobile phone;

FIG. 5 is another perspective view of the mobile phone, case system, and stand of FIG. 3, wherein the mobile phone and case system are positioned in the stand in a portrait orientation;

FIG. 6 is a perspective view of a mobile phone and a case system according to this invention, wherein the mobile phone is receiving an incoming call;

FIG. 7 is a perspective view of a mobile phone and a case system according to this invention, wherein the mobile phone is receiving a facebook update notification; and

FIG. 8 is perspective view of a mobile phone and a case system according to this invention, wherein the mobile phone is receiving a text message.

### DETAILED DESCRIPTION OF EXEMPLARY EMBODIMENTS

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated. Additionally, while the following detailed descriptions and embodiments relate to use with a mobile phone, it should be appreciated that the disclosed case system can be used with other portable or mobile electronic devices such as tablet computers, personal digital assistance, e-readers, portable media devices and the like.

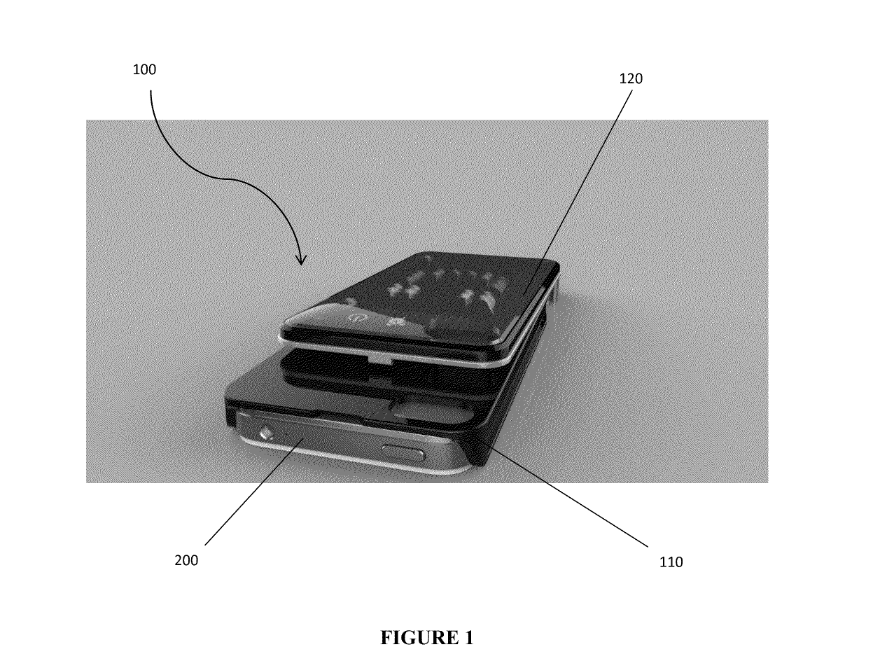

As shown in FIG. 1, a case system 100 for a mobile phone 200 includes a protective shell 110, and a back plate 120. The protective shell 110 substantially encloses the mobile phone 200 to protect the mobile phone 200 from damage. In the exemplary embodiment, shown in FIG. 1, the protective shell 110 substantially covers four surfaces of the mobile phone 200 with orifices included to provide access to buttons and to avoid obstructing features of the mobile phone 200, such as, for example, speakers, headphone jacks, data communication ports, power plugs or ports, or a camera lens of the mobile phone 200.

In the embodiment shown in FIG. 1, a fifth surface (e.g., a top surface) of the mobile phone 200 is not substantially covered by the protective shell 110 of the case system 100. In such exemplary embodiments, the protective shell 110 may extend in front of the fifth surface and/or may extend over an outer edge of the fifth surface such that when the mobile phone 200 is placed or dropped on an object with the fifth surface facing that object, the fifth surface is elevated above the object by the portion of the protective shell that extends beyond the fifth surface or onto the outer edge of the fifth surface. Likewise, a sixth surface (e.g., a front surface) of the mobile phone 200 may be similarly protected with limited or no direct coverage by the protective shell 110. It should also be appreciated that the backplate 120 may include orifices, cutouts, gaps or the like to correspond with any orifices in the protective shell 110.

Further, as shown in FIG. 1, the protective shell 110 and the backplate 120 may include a snap, living hinge, or other interfacing surface to help connect the backplate 120 to the protective shell 110. Furthermore, in various exemplary embodiments, the protective shell 110 and the backplate 120 may be integrated into a single piece.

In various exemplary embodiments, one or more snaps, clips, keyhole-shaped channels or the like may be utilized to attach the backplate 120 to the protective shell 110. In such exemplary embodiments, the protective shell 110 can be left attached to the mobile phone 200 while the backplate 120 is disconnected to, for example, charge a battery in the backplate 120. Likewise, when not needed to charge the battery of the mobile phone 200, the backplate can be left disconnected from the protective shell 110 without sacrificing substantial protection of the mobile phone 200. Further, the shape and orientation of the backplate 120 may be designed to limit the cargo space needed to carry or store the backplate 120 when disconnected from the protective shell 110. For example, the backplate 120 may be substantially planar such that it connects to a substantially planar back surface of the protective shell 110 without substantially overlapping or wrapping around the side surfaces of the protective shell 110. In such exemplary embodiments, the backplate 120 does not need extra space to account for the non-planar design elements of other battery enabled protective cases. In various exemplary embodiments, the snaps, clips, keyhole-shaped channels or similar features allow for various interchangeable components of the case system 100 to connect to the protective shell 110. For example, different battery enabled backplates 120 may be interchanged to extend the battery life of the case system 110 and/or the mobile phone 200 and/or cover plates or ornately designed case systems components may be connected to the protective shell to present a uniform planar surface or to change the ornamental design of the case system 100.

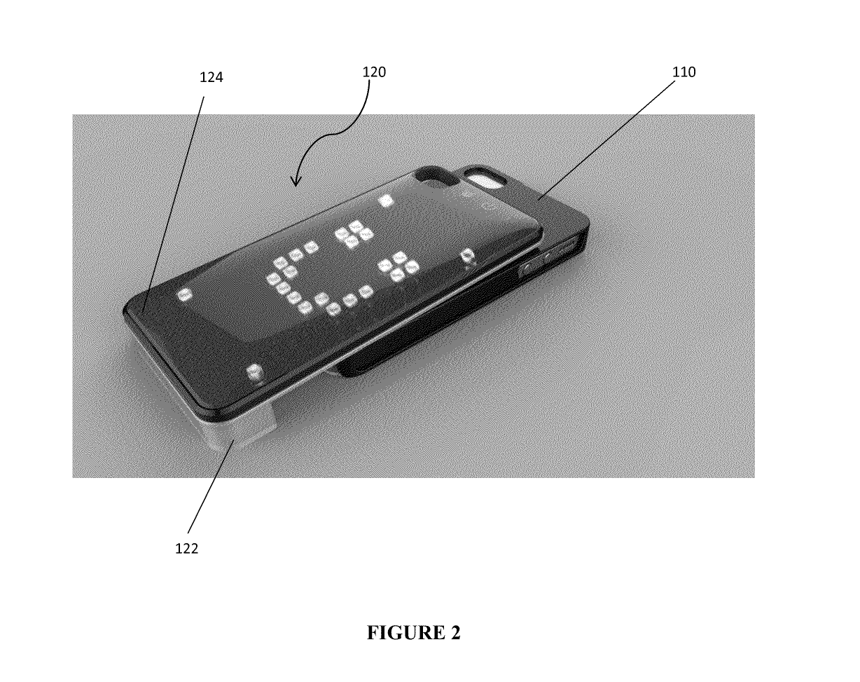

As shown in FIG. 2, in various exemplary embodiments, the backplate 120 may include a connection sled 122 and a display cover 124. The connection sled 122 connects to the mobile phone via a socket, port, dock, connection interface or the like. In various exemplary embodiments, the connection sled provides communication between the mobile phone 200 and the case system 100. In various exemplary embodiments, the connection sled provides an electrical connection between the mobile phone 200 and the case system 100. In such exemplary embodiments, the electrical connection may be used, for example, to charge a battery of the mobile phone 200 from an expansion battery in the case system 100.

It should be appreciated that the connection sled 122 and the display cover 124 may be connected to each other in any desirable manner. In various exemplary embodiments, one or more sockets, plugs, ports, exposed connections or the like are provided on a planar surface of each of the connection sled 122 and the display plate 124 that face each other such that the connection sled and the display plate are electrically connected when the two are aligned with the planar surfaces facing each other. In various exemplary embodiments, the connection sled 122 and the display plate 124 are connected in the same or similar manner as the contact plate and back plate described in U.S. Provisional Patent Application 61/676,583, filed on Jul. 27, 2012, the disclosure of which is hereby incorporated herein in its entirety.

It should be appreciated that, in various exemplary embodiments, the display cover 124 may be interchangeable such that a user can replace the display cover 124 with a blank cover, a stylized cover, a colored cover, an additional display cover or the like. In various exemplary embodiments, the interchangeable display cover 124 can be utilized to provide multiple charged covers to extend the battery life of the case system 100 and/or the phone 200. Further, the display cover 124 may be interchangeable to, for example, upgrade or change the display technology. Likewise, the connection sled 122 may be interchangeable to, for example, change the color of the connection sled 122. Further, in various exemplary embodiments, the connection sled 122 and the display cover 124 may be integrated into a single piece.

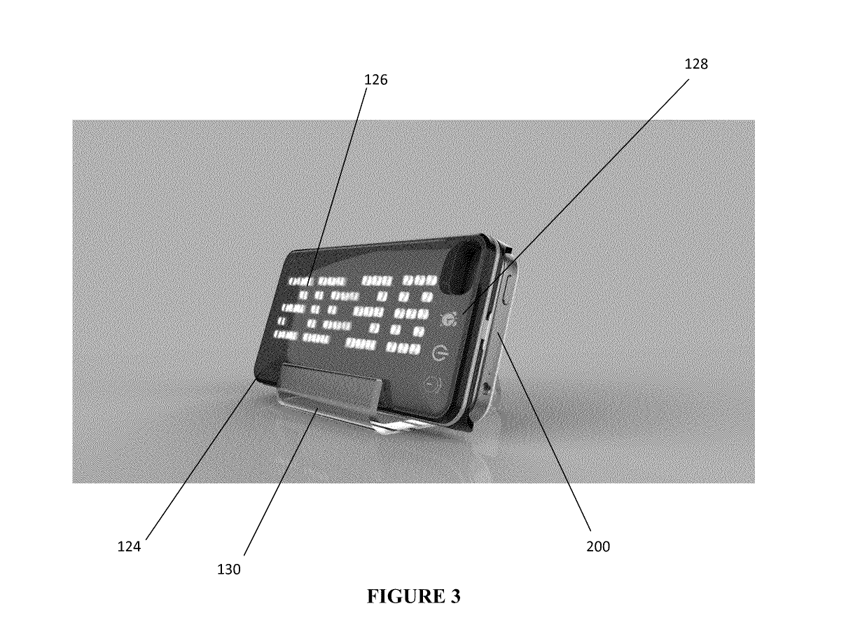

As shown in FIG. 3, the display plate 124 includes one or more light emitting diodes (LEDs) 126. In the embodiment shown in FIGS. 1-3, the LEDs 126 are arranged in a grid-like pattern and emit one or more different colors of light. Additionally, in various exemplary embodiments, the LEDs 126 are surface mount devices with a reduced foot print compared to other types of LEDs. However, it should be appreciated that other types of LEDs, displays or the like can also be used.

It should be appreciated the display plate 124 may be replaced with a different display plate to, for example, change the color of the LEDs or change the pattern in which the LEDs are placed on the display plate. Further, the display plate 124 may be replaced to, for example, change the display technology. For example, in various exemplary embodiments, the display plate 124 may be upgraded to provide a display plate 124 with an integrated LCD panel, OLED panel or any other desirable display technology.

In various exemplary embodiments, the back plate 120 may also include one or more buttons 128. In the embodiment shown in FIG. 3, the buttons 128 are provided on the display plate 124. However, it should be appreciated that the buttons 128 may alternatively or additionally be provided on the connection sled 122 and/or the protective shell 110.

The buttons 128 may be used to pair the case system 100 with the mobile phone 200 via a bluetooth or other wireless connection; activate a desired function of the case system 100, such as, for example initiating a clock function of the case system 100; turn off the case system 100; or perform or activate any other desired function. For example, the buttons 128 may be usable to turn off or disconnect the case system 100 from the mobile phone 200 to terminate a charging connection between the case system 100 and the mobile phone 200.

Likewise, the buttons 128 may be utilized to display or determine the current charged battery capacity of the case system 100. In various exemplary embodiments, the current charged battery capacity of the case system may be displayed through one or more LEDs or by utilizing the display plate 124. For example, in various exemplary embodiments, the current charged battery capacity of the case system is displayed by activating one or more LEDs in relation to the current charged battery capacity (e.g., activating four of four LEDs to indicate a charged battery capacity greater than 75%; activating three of four LEDs to indicate a charged battery capacity between 50% and 75%; activating two of four LEDs to indicate a charged battery capacity between 25% and 50%; activating one of four LEDs to indicate a charged battery capacity between 5 and 25%; and a blinking single LED for a current charged battery capacity less than 5%). It should be appreciated that any correlation between activated LEDs and charged battery capacity can be used. For example, in various exemplary embodiments, the case system 100 includes five LEDs each of which, when activated, indicates an increase of 20% in the current charged capacity. In other exemplary embodiments, a bar graph or similar graphic may be displayed on the display plate 124 to indicate the current charged battery capacity of the case system 100.

In various exemplary embodiments, a single button can be utilized to determine the current charged battery capacity and to turn on or off the case system 100 (e.g., electrically connect or disconnect the case system 100 from the mobile phone 200 to activate or deactivate a charging function of the case system 100). In such exemplary embodiments, a short press of the button may display the current charged battery capacity of the case system 100 while a longer held press of the button turns the case system on or off. In various exemplary embodiments, the buttons 128 are touch buttons, such as, for example, capacitive switches, resistive touch buttons, or the like.

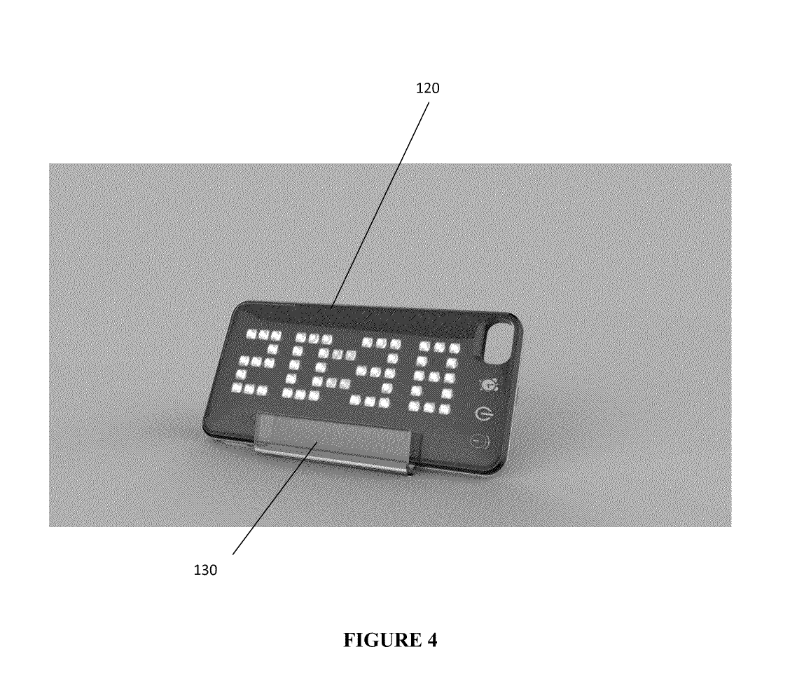

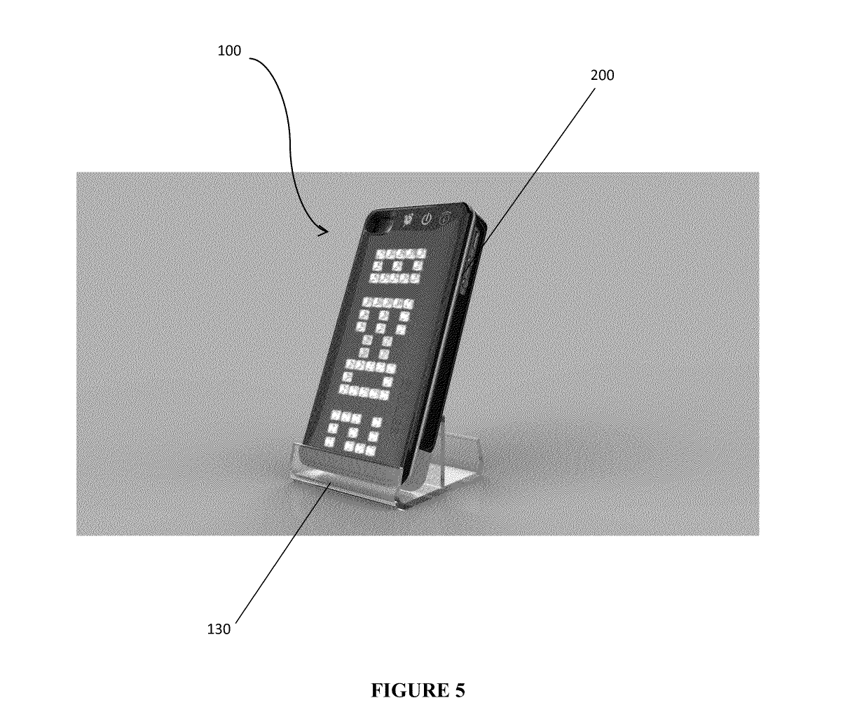

FIG. 3 shows the case system 100 in a digital clock mode. When the case system 100 is in the digital clock mode, the LEDs 126 are activated in a pattern to indicate the current time. It should be appreciated that other features typically present in a clock may be implemented as well. For example, the digital clock mode may include alarms, world clocks, count-up and/or count-down timers or other features. As shown in FIG. 4, the backplate 120 does not need to be physically connected to the phone 200 or the protective shell 110 to perform the digital clock mode. In such exemplary embodiments, the backplate 120 may still be connected to the mobile phone 200 via a wireless connection and/or may be operating independently of the mobile phone 200. Additionally, as shown in FIGS. 3, 4 and 5, the case system 100 may include a stand 130 that is usable to help position the case system 100 and/or phone 200 in a desired orientation.

It should be appreciated that the case system 100 may be useable with additional items beyond the mobile phone 200. For example, in various exemplary embodiments, the case system 100 includes an output power port that is usable to attach the case system 100, and a battery included therein, to an additional device such as through a USB cable. In such exemplary embodiments, the case system 100, or components thereof, can be used as an external battery pack to power or charge mobile electronic devices. For example, in various exemplary embodiments, the back plate 120 includes a USB port that is usable to attach the back plate 120 to any desired mobile electronic device.

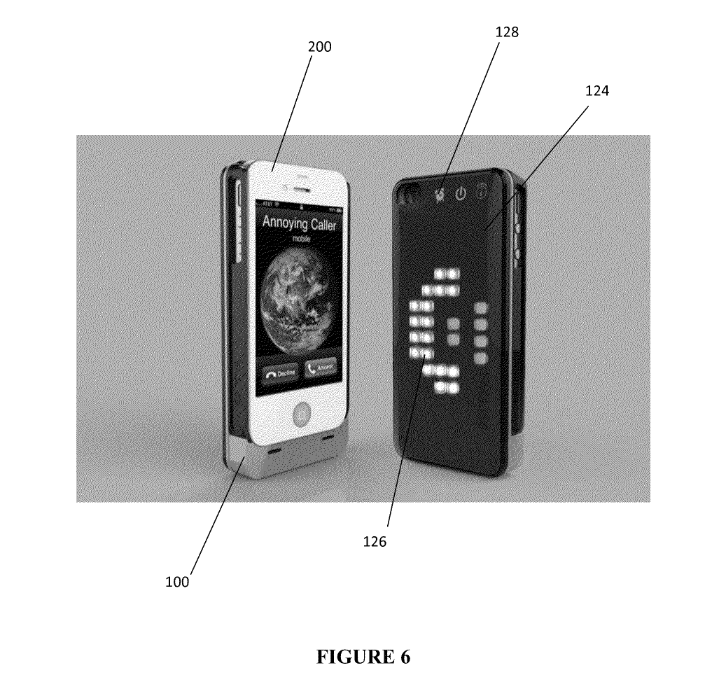

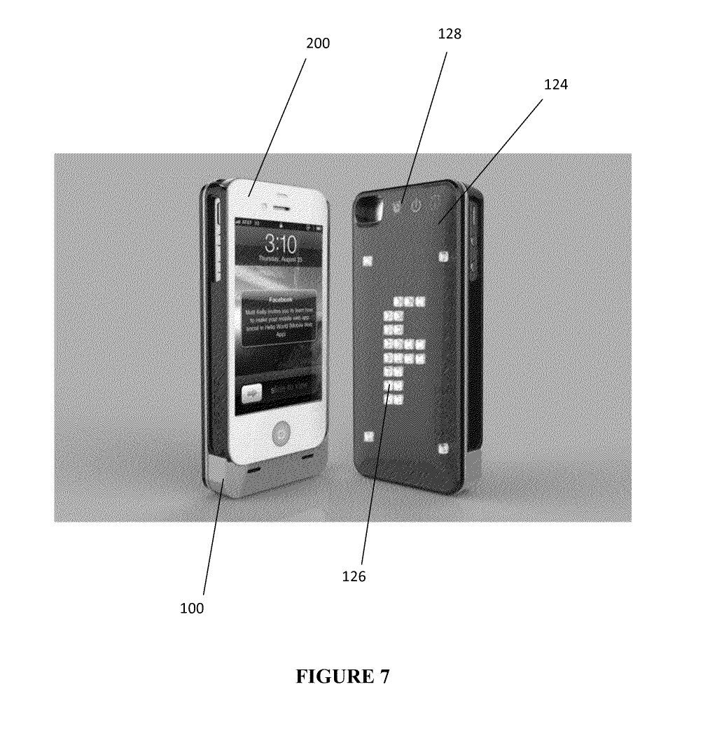

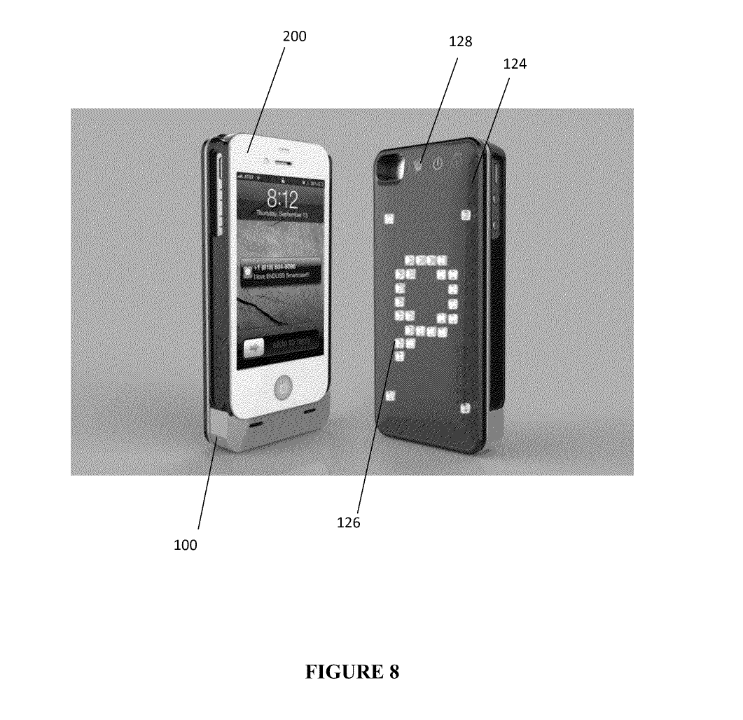

FIGS. 6, 7, 8 show alternative exemplary features of the case system 100. FIG. 6 shows an exemplary embodiment of the case system 100 demonstrating an incoming call notification feature. FIG. 7 shows an exemplary embodiment of the case system 100 demonstrating a facebook update notification feature. FIG. 8 shows an exemplary embodiment of the case system 100 demonstrating a text message notification feature. It should be appreciated that exemplary embodiments of the case system 100 may be capable of executing each and all of these features, one or more of the features, and/or additional features.

As shown in FIG. 6, the LEDs 126 on the display plate 124 can be used to indicate that the mobile phone 200 is receiving an incoming call. In the exemplary embodiment shown in FIG. 6, the LEDs 126 are illuminated in a design that represents a stylized classic telephone receiver. It should be appreciated that alternative designs may be used to indicate that the mobile phone 200 is receiving an incoming call. In general, any desired design or pattern can be used to indicate that the mobile phone 200 is receiving an incoming call, particularly designs that a user is likely to associate with the idea of a telephone or a phone call.

As shown in FIG. 7, the LEDs 126 on the display plate 124 can be used to indicate that the mobile phone 200 is receiving a facebook update alert. In the exemplary embodiment shown in FIG. 7, the LEDs 126 are illuminated in a design that represents a lowercase letter “f”. It should be appreciated that alternative designs may be used to indicate that the mobile phone 200 is receiving a facebook update alert. In general, any desired design or pattern can be used to indicate that the mobile phone 200 is receiving a facebook update alert, particularly designs that a user is likely to associate with facebook.

As shown in FIG. 8, the LEDs 126 on the display plate 124 can be used to indicate that the mobile phone 200 is receiving a text message. In the exemplary embodiment shown in FIG. 8, the LEDs 126 are illuminated in a design that represents a lowercase letter “a” or a “speech bubble” used in comics and cartoons. It should be appreciated that alternative designs may be used to indicate that the mobile phone 200 is receiving a text message. In general, any desired design or pattern can be used to indicate that the mobile phone 200 is receiving a text message, particularly designs that a user is likely to associate with text messages.

It should be appreciated that, in exemplary embodiments, the case system 100 can be used to indicate any alert, message, status, setting or other feature of the mobile phone 200. Additionally, other designs for the above-outlined or other features may be used. For example, in various exemplary embodiments, the LEDs 126 on the display plate 124 may be used to create a scrolling message. In such exemplary embodiments, the scrolling message may be used to indicate a name associated with an incoming call or text message, may scroll through the text of an incoming text message or may display any other desired messages or images to the user.

Likewise, in various exemplary embodiments, the user may be able to customize the case system 100 by providing custom images, icons, displays, messages or the like that are displayed via the LEDs on the display plate 124 when a given feature or function of the phone is activated. Further, the LEDs may be any desired color and/or may be a multi-color LED. In various exemplary embodiments, the color of the LEDs may be used to indicate a status or feature of the case or mobile phone. For example, the above-outlined designs may be displayed in a first color for contacts that are designated as family members and a second color for people designated as friends.

Additionally, in exemplary embodiments, the case system may be associated or accompanied by a software application. In such exemplary embodiments, the software application is compatible with and is run by the mobile phone 200. The software application allows the mobile phone 200 to communicate with a processor provided in the case system 100. The communication may operate over any known or later developed wired or wireless communication method such as, for example, via a wired connection through the connection sled 122, over a wireless Bluetooth connection, a personal area network connection, or a proprietary wireless connection. The processor in the case system 100 is usable to control the LEDs 126 and other functions of the display plate 124.

In various exemplary embodiments, the software application acts as a configuration tool allowing a user to alter settings, preferences, or other configurations of the case system 100. For example, in various exemplary embodiments, the software application is usable to choose from a list of available patterns to activate the LEDs 126 in a chosen pattern for a given event. Additionally, in various exemplary embodiments, the software application is usable to transfer a new pattern to the case system 100, to be stored in a memory provided in the case system 100. In various ones of these exemplary embodiments, the software application also includes a connection to an online store or marketplace to purchase additional patterns, functions or features for the case system 100.

In various exemplary embodiments, the software application may also include a custom pattern builder that allows a user to design a pattern to be displayed by the LEDs 126 and transfer that pattern to the case system 100 to be stored in a memory provided in the case system 100. Likewise, patterns may be stored locally on the phone and accessed by the case system 100 via a wired or wireless connection.

1. A mobile electronic case system comprising:
a first case system component usable to at least partially enclose a mobile electronic device, the first case system component having a first substantially planar back wall and one or more side walls extending generally perpendicular from the back wall around at least a portion of a perimeter of the back wall; and
a second case system component capable of mechanical and electrical attachment to the first case system component;
wherein the second case system component includes an expansion battery usable to charge a native battery in the mobile electronic device.

2. The mobile electronic case system of claim 1, wherein the second case system component includes a display usable to display information about the mobile electronic device.

3. The mobile electronic case system of claim 1, wherein the mobile electronic case system includes a transceiver usable to create a data connection with the mobile electronic device for exchanging information between the mobile electronic device and the mobile electronic case system.

4. The mobile electronic case system of claim 1, wherein the one or more side walls extend from a front surface of the back wall, the back wall including an opposing back surface, and wherein the back surface includes one or more mechanical interfaces usable to attach the second case system component to the first case system component.

5. The mobile electronic case system of claim 1, wherein at least one of the one or more side walls includes an interface receiving surface usable to receive a mechanical attachment projection of the second case system component.

6. The mobile electronic case system of claim 1, wherein the second case system component includes at least one electronic communication port usable to connect the second case system component to a desired electronic device.

7. The mobile electronic case system of claim 6, wherein the at least one electronic communication port is a universal serial bus (USB) port usable to provide a power connection to the desired electronic device.

8. The mobile electronic case system of claim 1, wherein the electronic case system includes a transceiver usable to create a data connection with the mobile electronic device for exchanging information between the mobile electronic device and the mobile electronic case system and wherein the second case system component includes a display usable to display information received from the electronic device.

9. The mobile electronic case system of claim 8, wherein the display is usable to display a graphic to represent the current charged capacity of a battery included in the mobile electronic case system.

10. The mobile electronic case system of claim 8, wherein the display is usable to display a graphic to indicate that the mobile electronic device is receiving a phone call.

11. The mobile electronic case system of claim 8, wherein the display is usable to display a graphic to indicate that the mobile electronic device is receiving a data communication.

12. The mobile electronic case system of claim 11, wherein the data communication is a text message.

13. The mobile electronic case system of claim 11, wherein the data communication is an electronic mail (email).

14. The mobile electronic case system of claim 8, wherein the display is usable to interact with an application installed on the mobile electronic device to indicate a message received from the application.

15. A mobile electronic case system comprising:
a protective shell usable to substantially enclose at least three surfaces of a mobile electronic device; and
a back plate detachably connected to the protective shell and providing an electrical connection to the mobile electronic device, wherein the back plate includes an expansion battery usable to charge a native battery in the mobile electronic device.

16. The mobile electronic case system of claim 15, wherein the back plate further includes a display.

17. A mobile electronic case system comprising:
a protective shell usable to substantially enclose at least three surfaces of a mobile electronic device; and
a series of interchangeable back plates that are interchangeably attachable to the protective shell.

18. The mobile electronic case system of claim 17, wherein the series of interchangeable back plates includes at least one decorative panel back plate usable to provide a desirable surface appearance to the mobile electronic case system and at least one power back plate usable including an expansion battery usable to charge a native batter of the mobile electronic device.

19. The mobile electronic case system of claim 18 wherein the at least one power back plate includes one or more light emitting diodes and a button wherein, when the button is pressed, the light emitting diodes are illuminated in a pattern that relates to the current charged capacity of the expansion battery.

20. The mobile electronic case system of claim 17, wherein only one interchangeable back plate can be attached to the protective shell at a time.
